(19) United States
(12) Patent Application Publication
(10) Pub. No.: US 2019/0286059 A1
(43) Pub. Date: Sep. 19, 2019

(54) TIMEPIECE STRIKING MECHANISM

(71) Applicant: Montres Breguet S.A., L'Abbaye (CH)

(72) Inventors: Marc JUNG, Bellefontaine (FR); Marc STRANCZL, Nyon (CH); Marc ABT, Fuans (FR); Benoit LEGERET, Ecublens (CH)

(73) Assignee: Montres Breguet S.A., L'Abbaye (CH)

(21) Appl. No.: 16/275,757

(22) Filed: Feb. 14, 2019

(30) Foreign Application Priority Data
Mar. 13, 2018 (EP) 18161568.3

(51) Int. Cl. G04B 21/06; G04B 21/02

(52) U.S. Cl. CPC G04B 21/06; G04B 21/02

(57) ABSTRACT

A timepiece striking mechanism including a mechanism for controlling at least one hammer including a first striking area arranged to strike, in a first direction of travel, a first resonant component on a first striking surface when this at least one hammer moves from a recoiled position to a first impact position, this hammer including, opposite to the first striking area, a second striking area arranged to strike, in a second direction of travel opposite to the first direction of travel, when the hammer recoils from the first impact position to the recoiled position, a second striking surface comprised either in the first resonant component or a second resonant component distinct from the first resonant component.

### FIELD OF THE INVENTION

The invention concerns a timepiece striking mechanism comprising a mechanism for controlling at least one hammer, which includes a first striking area, which is arranged to strike, in a first direction of travel, a first resonant component on a first striking surface, when the at least one hammer moves from a recoiled position to a first impact position.

The invention also concerns a timepiece mechanism including such a striking mechanism.

The invention also concerns a timepiece, especially a watch, including such a timepiece mechanism, and/or such a striking mechanism.

The invention concerns the field of sound emitting timepiece mechanisms, such as striking or alarm mechanisms, musical boxes and suchlike.

### BACKGROUND OF THE INVENTION

Timepiece striking or alarm mechanisms generally comprise a hammer, which strikes a gong or suchlike.

The rebound of the hammer on the gong can produce unwanted noise, particularly if the hammer strikes a fixed element, such as a plate, during its return travel. Consequently, the sound produced by the striking or alarm mechanism is neither elegant nor controlled.

French Patent No FR326530A in the name of STANGE discloses a musical escapement mechanism for an alarm clock, wherein this escapement only performs after the alarm chime and is obtained by means of a cam disc which is fixed on the alarm mounting arbor and in its last backward rotation activates a lever, which in turn acts on an escape lever controlling the musical mechanism.

French Patent No FR349486A in the name of HALLER discloses a striking table or alarm clock comprising an oscillating bell device provided beyond its axis of oscillation with an arbor that engages in the winding groove of a control wheel, rotation of which determines the bell swing.

French Patent No FR380459A in the name of HAMBURG AMERIKANISCHE UHRENFABRIK discloses the application to an alarm clock of one or more acoustic exciters which are composed of acoustic horns with membranes and are struck by means of one or more hammers. One of the types of this novel gong has a single acoustic exciter, so that the acoustic horn is rotated forwards and so that the swing plane of the hammer is perpendicular on the membrane and thus the hammer is started from the axis of the alarm clock pallets, by means of a hook which enters a loop fixed to the hammer arbor. Another type of this gong has several acoustic exciters, so that the membranes of two pairs of exciters are placed opposite the front surfaces of a hammer to obtain a series of fast sounds.

### SUMMARY OF THE INVENTION

The invention proposes to remove unwanted noise related to hammer rebound, by replacing the single strike with a double strike on a single gong or on two gongs, which may be tuned either to the same frequency, or to different frequencies.

To this end, the invention concerns a striking mechanism according to claim 1.

The invention also concerns a timepiece mechanism including such a striking mechanism.

The invention also concerns a timepiece, especially a watch, including such a timepiece mechanism and/or such a striking mechanism.

### BRIEF DESCRIPTION OF THE DRAWINGS

Other features and advantages of the invention will appear from reading the following detailed description, with reference to the annexed drawings, in which:

FIG. 1 represents a schematic plan view of a striking mechanism according to a first alternative of the invention.

FIG. 2 represents a perspective view of a detail of the mechanism of FIG. 1.

FIG. 3 represents, in a similar manner to FIG. 1, a striking mechanism according to a second alternative of the invention.

FIG. 4 represents, in a similar manner to FIG. 1, a striking mechanism according to a third alternative of the invention.

FIG. 5 is a block diagram representing a timepiece, notably a watch, including a timepiece mechanism comprising such a striking mechanism, controlled by a timepiece movement and/or an actuator arranged to be operated by a user.

### DETAILED DESCRIPTION OF PREFERRED EMBODIMENTS

To avoid the harmful effects of a hammer rebounding on a gong, a first alternative consists in forming a hammer that strikes the gong in both directions of movement. Such a hammer may, for example, straddle the gong. In a first anticlockwise direction, the hammer strikes the gong as in a conventional structure, via a first striking area of the hammer. In a second direction, opposite to the first direction, the hammer also strikes the same gong, but via a second striking area of the hammer, different from the first striking area and which is opposite thereto.

A second alternative consists in placing another element of the main gong, for example a second branch, such that a strike occurs in both directions of rotation of the hammer.

A second variant consists in arranging two striking work gongs, one on each side of the hammer. Each gong is activated by a different direction of the hammer. This solution is advantageous if one wishes to produce two different sounds, when the two gongs are chosen to be acoustically distinct.

Thus, the invention concerns a timepiece striking mechanism 100 including a mechanism for controlling at least one hammer 1.

A ‘striking mechanism’ means, in the broad sense, any timepiece mechanism emitting a sound: a striking or alarm mechanism, musical box, or otherwise.

This at least one gong 1 has a first striking area 2, which is arranged to strike, in a first direction of travel, a first resonant component 3 on a first striking surface 30 of the latter, when the at least one hammer 1 moves from a recoiled position to a first impact position.

This at least one hammer 1 includes, opposite to first striking area 2, a second striking area 5 which is arranged to strike, in a second direction of travel opposite to the first direction of travel, when the at least one hammer 1 recoils from the first impact position to the recoiled position, a second striking surface 40 comprised, either in first resonant component 3 in a first variant, or in a second resonant component 4 distinct from first resonant component 3 in a second variant.

The first resonant component 3 or second resonant component 4 is illustrated in a non-limiting manner in the Figures, in the usual form of a gong. It may also consist of a disc-gong, a bell, a comb, or otherwise. More particularly, this first resonant component 3, and/or this second resonant component 4, is a gong or a disc-gong or a bell or a comb, fixed in a cantilevered arrangement to a fixed structure 8, comprised in striking mechanism 100, at a first point of attachment or second point of attachment respectively.

More particularly, the control mechanism comprises a control wheel set 10 which is arranged to directly or indirectly control the movement of the at least one hammer 1.

In a first variant, the first resonant component 3 includes the second striking surface 40.

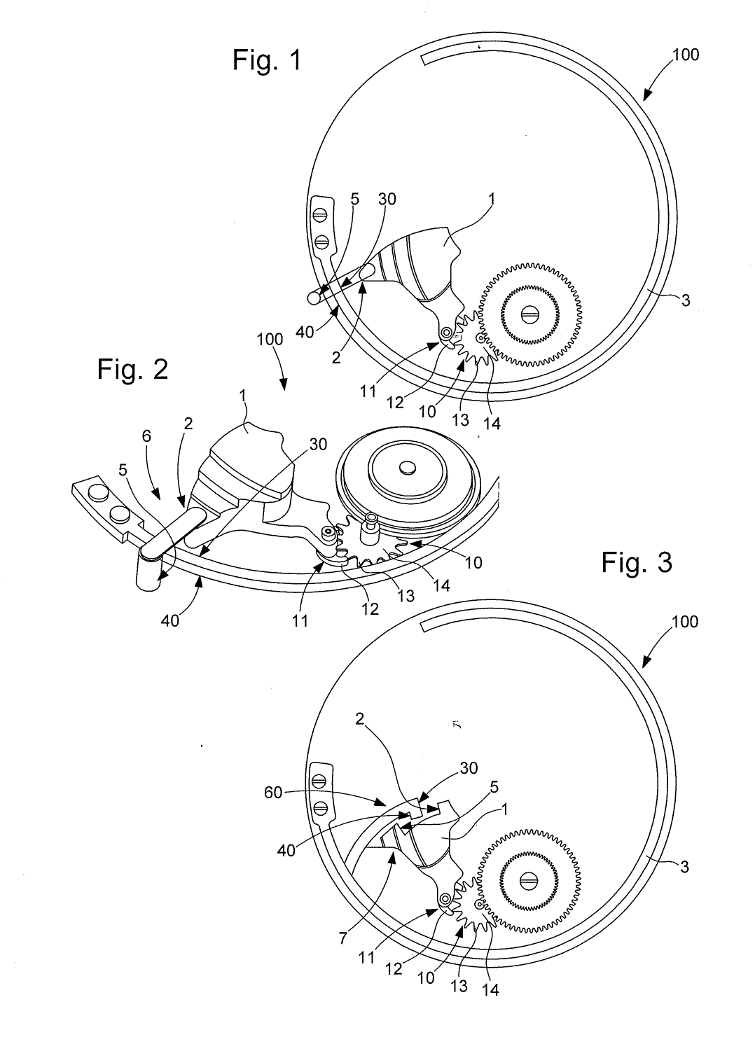

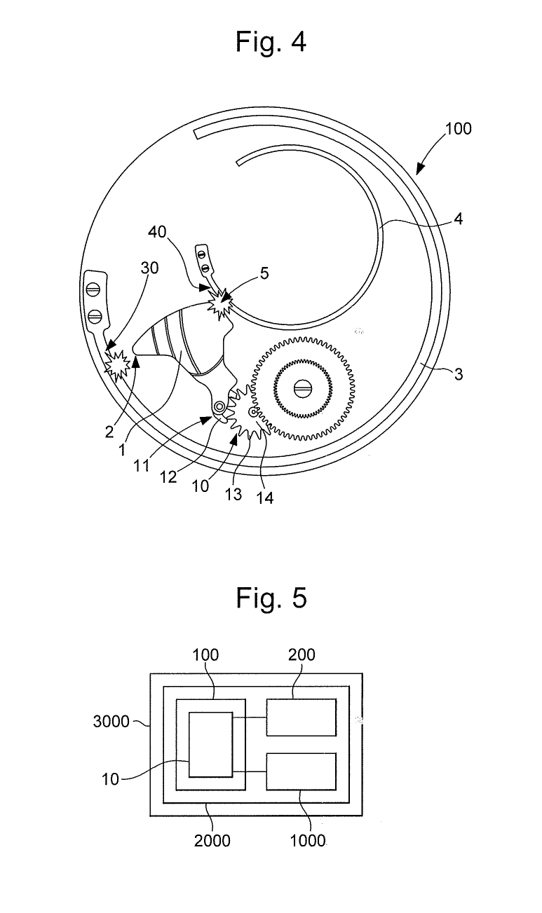

In a first embodiment of this first variant, this second striking surface 40 is in immediate proximity to first striking surface 30, from which it is separated by the thickness of first resonant component 3, as seen in FIGS. 1 to 3.

In a second embodiment of this first variant, the distance between the first point of attachment and second striking surface 40 is different from the distance between said same first point of attachment and first striking surface 30.

According to the first alternative, as seen in FIGS. 1 and 2, hammer 1 includes a first fork 6, which is arranged to straddle first resonant component 3, and which includes, on either side of first resonant component 3, first striking area 2 and second striking area 5.

In another embodiment, hammer 1 includes a substantially annular element arranged to surround first resonant component 3 and which includes, on either side of first resonant component 3, first striking area 2 and second striking area 5.

According to the second alternative, first resonant component 3 includes a second fork 60, which is arranged to straddle a second end 7 of hammer 1 which includes second striking area 5 and which second fork 60 includes, on either side of second end 7, first striking surface 30 and second striking surface 40. More particularly, and as seen in FIG. 3, hammer 1 forms a U, each branch of which includes a striking area.

According to the second variant, striking mechanism 100 includes a second resonant component 4, which includes second striking surface 40.

In a particular embodiment, the first point of attachment and second point of attachment coincide.

In another particular embodiment, the first point of attachment and second point of attachment are distinct.

In another particular embodiment, the distance between the second point of attachment and second striking surface 40 is different from the distance between the first point of attachment and first striking surface 30.

In yet another particular embodiment, the distance between the second point of attachment and second striking surface 40 is identical to the distance between the first point of attachment and first striking surface 30.

In a particular embodiment, second resonant component 4 has a different fundamental resonance frequency from that of first resonant component 3.

In yet another particular embodiment, second resonant component 4 has an identical fundamental resonance frequency to that of first resonant component 3.

More particularly, control wheel set 10 is arranged to control the movement of at least one pallet lever 11, which is in turn arranged to control a movement of at least one hammer 1 from its recoiled position to its impact position. According to a particular feature, control wheel set 10 includes a wheel 14, and this at least one pallet lever 11 includes a plurality of beaks 12, each arranged to cooperate with one of teeth 13 comprised in wheel 14. More particularly, this at least one pallet lever 11 includes two beaks 12 alternatively meshing with wheel 14.

In a particular embodiment, at least one anchor-piece? 11 is at least pivotally joined to at least one hammer 1, in order to pivot with respect to a fixed structure 8, such as a plate, bridge, or suchlike. More particularly still, the at least one pallet lever 11 is integral with at least one hammer 1.

The invention also concerns a timepiece movement 2000 including such a striking mechanism 100. More particularly, this mechanism 2000 includes an actuator 200, which is able to be operated by a user to drive control wheel set 10, and/or includes a timepiece movement 1000 able to drive control wheel set 10.

The invention also concerns a timepiece movement 3000 including such a striking mechanism 2000, and/or such a striking mechanism 100. More particularly, this timepiece 3000 is a watch.

The invention avoids energy loss when the hammer rebounds; energy is restored after the hammer changes direction of rotation, increasing the sound level of the striking mechanism.

The different structure variants protect the hammer and the plate from any impact with each other.

1. A timepiece striking mechanism comprising a mechanism for controlling at least one hammer which includes a first striking area arranged to strike, in a first direction of travel, a first resonant component on a first striking surface when said at least one hammer moves from a recoiled position to a first impact position, wherein said at least one hammer includes, opposite to said first striking area, a second striking area arranged to strike, in a second direction of travel opposite to said first direction of travel, when said at least one hammer recoils from said first impact position to said recoiled position, a second striking surface comprised, either in said first resonant component, or in a second resonant component distinct from the first resonant component, wherein said first resonant component includes said second striking surface, said first resonant component, either comprises said second striking surface in immediate proximity to said first striking surface from which said second striking surface is separated by the thickness of said first resonant component, or is a gong or a disc-gong, or a bell or a comb, fixed in a cantilevered arrangement to a fixed structure, comprised in said striking mechanism, at a first point of attachment, and such that the distance between said first point of attachment and said second striking surface which is different from the distance between said first point of attachment and said first striking surface, and further wherein, when said second resonant component includes said second striking surface, said first resonant component is a gong or disc-gong or a bell or a comb, fixed in a cantilevered arrangement to a structure of said striking mechanism at a first point of attachment, and said second resonant component is a gong or a disc-gong or a bell or a comb fixed in a cantilever arrangement to a structure of said striking mechanism at a second point of attachment.

2. The striking mechanism according to claim 1, wherein said first resonant component includes said second striking surface in immediate proximity to said first striking surface, from which said second striking surface is separated by the thickness of said first resonant component.

3. The striking mechanism according to claim 1, wherein said first resonant component is a gong or a disc-gong or a bell or a comb, fixed in a cantilevered arrangement to a fixed structure comprised in said striking mechanism, at a first point of attachment, and wherein the distance between said first point of attachment and said second striking surface is different from the distance between said first point of attachment and said first striking surface.

4. The striking mechanism according to claim 1, wherein said hammer comprises a first fork arranged to straddle said first resonant component and which includes, on either side of said first resonant component, said first striking area and said second striking area.

5. The striking mechanism according to claim 1, wherein said hammer includes a substantially annular element arranged to surround said first resonant component and which includes, on either side of said first resonant component, said first striking area and said second striking area.

6. The striking mechanism according to claim 1, wherein said first resonant component includes a second fork arranged to straddle a second end of said hammer that includes said second striking area and said second fork includes, on either side of said second end, said first striking surface and said second striking surface.

7. The striking mechanism according to claim 3, wherein said first resonant component includes a second fork arranged to straddle a second end of said hammer that includes said second striking area and said second fork includes, on either side of said second end, said first striking surface and said second striking surface.

8. The striking mechanism according to claim 1, wherein said striking mechanism includes a said second resonant component distinct from the first resonant component, said second resonant component includes said second striking surface, and in that wherein said first resonant component is a gong or a disc-gong or a bell or a comb, fixed in a cantilevered arrangement to a structure of said striking mechanism at said first point of attachment, and said second resonant component is a gong or a disc-gong or a bell or a comb, fixed in a cantilevered arrangement to a structure of said striking mechanism at said second point of attachment.

9. The striking mechanism according to claim 8, wherein said first point of attachment and said second point of attachment coincide.

10. The striking mechanism according to claim 8, wherein said first point of attachment and said second point of attachment are distinct.

11. The striking mechanism according to claim 8, characterized in that the wherein said distance between said second point of attachment and said second striking surface is different from the distance between said first point of attachment and said first striking surface.

12. The striking mechanism according to claim 8, wherein said distance between said second point of attachment and said second striking surface is identical to the distance between said first point of attachment and said first striking surface.

13. The striking mechanism according to claim 8, characterized in that wherein said second resonant component has a different fundamental frequency from that of said first resonant component.

14. The striking mechanism according to claim 8, wherein said second resonant component has an identical fundamental frequency to that of said first resonant component.

15. The striking mechanism according to claim 1, wherein said control mechanism includes a control wheel set arranged to control the movement of at least one pallet lever, in turn arranged to control a movement of at least one said hammer from its recoiled position to its impact position.

16. The striking mechanism according to claim 15, wherein said control wheel set includes a wheel, and wherein said at least one pallet lever has two beaks alternatively meshing with said wheel.

17. The striking mechanism according to claim 15, wherein said at least one pallet lever is at least pivotally joined to at least one said hammer, to pivot with respect to a fixed structure.

18. The striking mechanism according to claim 17, wherein said at least one pallet lever is integral with at least one said hammer.

19. A timepiece mechanism including comprising a striking mechanism according to claim 1, and an actuator able to be operated by a user to drive said control wheel set, and/or a timepiece movement able to drive said control wheel set.

20. A watch comprising a timepiece movement according to claim 19.
